(19) United States
(12) Patent Application Publication
(10) Pub. No.: US 2014/0291017 A1
(43) Pub. Date: Oct. 2, 2014

(54) CONNECTOR AND WIRE HARNESS

(71) Applicant: Hitachi Metals, Ltd., Tokyo (JP)

(72) Inventors: Tomoya KUJI, Yokohama (JP); Sachio SUZUKI, Hitachi (JP); Yuta KATAOKA, Hitachi (JP); Jun UMETSU, Hitachi (JP); Takanori KOMURO, Hitachi (JP)

(73) Assignee: Hitachi Metals, Ltd., Tokyo (JP)

(21) Appl. No.: 14/227,204

(22) Filed: Mar. 27, 2014

(30) Foreign Application Priority Data
Mar. 29, 2013 (JP) 2013-073082

(51) Int. Cl. H01R 13/46; H01B 7/00

(52) U.S. Cl. CPC H01R 13/46; H01B 7/0045
USPC 174/72 A; 439/626

(57) ABSTRACT

A connector includes a first terminal housing for housing first connecting terminals, a second terminal housing for housing second connecting terminals, insulating members aligned and housed in the second terminal housing, a connecting member for rotating a cam in a tightening direction and thereby pressing each contact point, a first fitting detection terminal provided on one of the first and second terminal housings, a second fitting detection terminal provided on the other of the first and second terminal housings so as to be slidable along a fitting direction of the two terminal housings, and a slide means that makes the second fitting detection terminal slide in accordance with the rotation of the cam and electrically connects the first fitting detection terminal to the second fitting detection terminal when fitting the two terminals housings and then rotating the cam in the tightening direction.

The present application is based on Japanese patent application No. 2013-073082 filed on Mar. 29, 2013, the entire contents of which are incorporated herein by reference.

### BACKGROUND OF THE INVENTION

1. Field of the Invention

The invention relates to a connector to be suitably used for a power harness used in eco-friendly cars such as hybrid cars and electric cars especially to transmit a large amount of power, and a wire harness.

2. Description of the Related Art

A power harness is used for connecting between devices such as between a motor and an inverter or between an inverter and a battery in, e.g., a hybrid car or an electric car, which has made significant progress in recent years, for transmitting a large amount of power, and a connector in a two-divided structure composed of, e.g., a first connector portion provided with a first terminal(s) as well as a first terminal housing for housing the first terminal(s) and a second connector portion provided with a second terminal(s) connected to the first terminal(s) as well as a second terminal housing for housing the second terminal(s) is provided to one end of the power harness.

In recent years, all components in such eco-friendly cars have been lightened in weight in order to improve energy saving performance, and size reduction is desired as one of effective means of reducing weight.

The present applicant has proposed a laminated-type connector having a laminated structure in which, when a first terminal housing is fitted to a second terminal housing, plural first connecting terminals and plural second connecting terminals are alternately arranged so that surfaces of the first connecting terminals respectively face surfaces of the second connecting terminals to form pairs and plural contact points formed therebetween are sandwiched between the insulating members (Japanese patent No. 4, 905, 608).

In the connector of Japanese patent No. 4, 905, 608, a connecting member is provided to press an insulating member adjacent thereto to collectively fix and electrically connect the plural first connecting terminals to the plural second connecting terminals at each contact point, and an insulating member assembly is formed by connecting the plural insulating members to each other and restricts the insulating members from moving in a fitting direction and a width direction which is perpendicular to a lamination direction of the laminated structure and to the fitting direction.

Such a configuration realizes a small laminated-type connector by eliminating a retaining jig for holding the insulating members and also allows positional misalignment of the insulating members to be reduced even in the case that an excessive force is applied to a cable.

In the meantime, in a connector used for transmitting a large amount of power as described above, since spark may be generated by arc discharge if the fitting of the two terminal housings is released while an electric current is still flowing, which is dangerous for work and may damage terminals, etc.

Thus, a device to detect the fitting of two terminals and to interrupt an electric current when releasing the fitting of the two terminals (High Voltage Interlock Loop (HVIL) etc.) is sometimes provided.

Japanese patent No. 3, 820, 355 proposes a device configured that two terminal housings are fitted and a first fitting detection terminal provided on one of the terminal housings subsequently slides and comes into contact with a second fitting detection terminal provided on another terminal housing so that a power circuit is connected when the two fitting detection terminals are in a contact state and the power circuit is interrupted when the two fitting detection terminals are in a non-contact state.

### SUMMARY OF THE INVENTION

If the technique of Japanese patent No. 3, 820, 355 is applied to a laminated-type connector, it is necessary to firstly fit two terminal housings and then to fix each contact point by operating a connecting member and further to slide the first fitting detection terminal. Therefore, it takes time and effort when fitting two terminal housings and connecting two connector portions, which is a problem in view of workability.

In addition, when the technique of Japanese patent No. 3, 820, 355 is applied to a laminated-type connector, two fitting detection terminals could be electrically connected by sliding of the first fitting detection terminal even in a state that each contact point is not fixed. Accordingly, there is a possibility that two terminal housings are detached even though two fitting detection terminals are still electrically connected and spark is generated, which is also a problem in view of safety.

It is an object of the invention to provide a laminated-type connector that can detect the fitting of terminal housings without impairing the workability and the safety of connection work, as well as a wire harness using the connector.

(1) According to one embodiment of the invention, a connector comprises:

a first terminal housing for housing a plurality of first connecting terminals aligned;

a second terminal housing for housing a plurality of second connecting terminals aligned;

a plurality of insulating members aligned and housed in the second terminal housing;

a laminated structure that the plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the first terminal housing is fitted to the second terminal housing;

a connecting member for collectively fixing and electrically connecting the plurality of first connecting terminals and the plurality of second connecting terminals at each contact point by rotating a cam in a tightening direction and thereby pressing each contact point;

a first fitting detection terminal provided on one of the first and second terminal housings;

a second fitting detection terminal provided on the other of the first and second terminal housings so as to be slidable along a fitting direction of the two terminal housings; and

a slide means that makes the second fitting detection terminal slide in accordance with the rotation of the cam and electrically connects the first fitting detection terminal to the second fitting detection terminal when fitting the two terminals housings and then rotating the cam in the tightening direction.

In the above embodiment (1) of the invention, the following modifications and changes can be made.

(i) The slide means is configured to electrically connect the first fitting detection terminal to the second fitting detection terminal after a pressing force is applied to each contact point when fitting the two terminals housings and then rotating the cam in the tightening direction.

(ii) The slide means is configured to electrically disconnect the first fitting detection terminal from the second fitting detection terminal when the cam is rotated from a tightened position in a direction opposite to the tightening direction.

(iii) The slide means is configured to electrically disconnect the first fitting detection terminal from the second fitting detection terminal and subsequently to release each contact point from the pressing force when the cam is rotated from the tightened position in the direction opposite to the tightening direction.

(iv) The connector further comprises a second fitting detection terminal case for holding the second fitting detection terminal,

wherein the slide means comprises a case-side protrusion provided on the second fitting detection terminal case and a slide ring comprising a ring portion rotating integrally with the cam and a ring-side protrusion coming in contact with the case-side protrusion to slide the second fitting detection terminal case when the ring portion is rotated.

(v) The ring-side protrusion comprises two protrusions, a front protrusion formed along a circumferential direction of the ring portion and a rear protrusion,

wherein the rear protrusion butts against the case-side protrusion to slide the second fitting detection terminal case when fitting the two terminals housings and then rotating the cam in the tightening direction, and

wherein the front protrusion butts against the case-side protrusion to slide the second fitting detection terminal case in a direction opposite to the first fitting detection terminal when the cam is rotated from a tightened position in a direction opposite to the tightening direction.

(vi) The connector further comprises a case-side auxiliary protrusion formed on the second fitting detection terminal case on a front side in a sliding direction with respect to the case-side protrusion,

wherein, when fitting the two terminals housings and then rotating the cam in the tightening direction, the front protrusion butts against the case-side auxiliary protrusion to slide the second fitting detection terminal case toward the first fitting detection terminal and subsequently the rear protrusion butts against the case-side protrusion to slide the second fitting detection terminal case toward the first fitting detection terminal.

(2) According to another embodiment of the invention, a connector comprises:

a second terminal housing for housing a plurality of second connecting terminals aligned;

a plurality of insulating members aligned and housed in the second terminal housing;

a laminated structure that a plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the second terminal housing is fitted to a first terminal housing that is a housing to be fitted to the second terminal housing and houses the plurality of first connecting terminals aligned;

a connecting member for collectively fixing and electrically connecting the plurality of first connecting terminals and the plurality of second connecting terminals at each contact point by rotating a cam in a tightening direction and thereby pressing each contact point;

a second fitting detection terminal provided on the second terminal housing so as to be slidable along a fitting direction of the two terminal housings; and

a slide means that makes the second fitting detection terminal slide in accordance with the rotation of the cam and electrically connects the first fitting detection terminal provided on the first terminal housing to the second fitting detection terminal when fitting the two terminals housings and then rotating the cam in the tightening direction.

(3) According to another embodiment of the invention, a wire harness comprises:

a plurality of cables;

a plurality of second connecting terminals to be connected to the plurality of cables;

a second terminal housing for housing the plurality of second connecting terminals aligned;

a plurality of insulating members aligned and housed in the second terminal housing;

a laminated structure that a plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the second terminal housing is fitted to a first terminal housing that is a housing to be fitted to the second terminal housing and houses the plurality of first connecting terminals aligned;

a connecting member for collectively fixing and electrically connecting the plurality of first connecting terminals and the plurality of second connecting terminals at each contact point by rotating a cam in a tightening direction and thereby pressing each contact point;

a second fitting detection terminal provided on the second terminal housing so as to be slidable along a fitting direction of the two terminal housings; and

a slide means that makes the second fitting detection terminal slide in accordance with the rotation of the cam and electrically connects the first fitting detection terminal provided on the first terminal housing to the second fitting detection terminal when fitting the two terminals housings and then rotating the cam in the tightening direction.

### Effects of the Invention

According to one embodiment of the invention, a laminated-type connector can be provide that can detect the fitting of terminal housings without impairing the workability and the safety of connection work, as well as a wire harness using the connector.

### BRIEF DESCRIPTION OF THE DRAWINGS

Next, the present invention will be explained in more detail in conjunction with appended drawings, wherein:

FIG. 1 is a cross sectional view showing a connector in the present embodiment;

FIGS. 2A and 2B are perspective views thereof;

FIGS. 3A and 3B are perspective views showing a first connector portion of the connector of FIG. 1;

FIG. 4 is a perspective view showing first connecting terminals of the first connector portion of FIGS. 3A and 3B;

FIG. 5 is a perspective view showing a first terminal housing and a first inner housing of the first connector portion of FIGS. 3A and 3B;

FIGS. 6A and 6B are perspective views showing a second connector portion of the connector of FIG. 1;

FIG. 7A is a perspective view showing the second connector portion of FIGS. 6A and 6B where the second terminal housing is removed;

FIG. 7B is a perspective view showing the second connector portion where the second inner housing is further removed;

FIG. 8 is a perspective view showing second connecting terminals of the second connector portion and cables of FIGS. 6A and 6B;

FIGS. 9A and 9B are perspective views showing the second inner housing of the second connector portion of FIGS. 6A and 6B;

FIGS. 10A and 10B are perspective views showing the second terminal housing of the second connector portion of FIGS. 6A and 6B;

FIG. 11 is a perspective view showing the state in which the second inner housing of FIGS. 9A and 9B is attached to the second terminal housing of FIGS. 10A and 10B;

FIGS. 12A to 12D are diagrams illustrating a connecting member of the second connector portion of FIGS. 6A and 6B, wherein FIG. 12A is a perspective view, FIG. 12B is a cross sectional view, FIG. 12C is a perspective view showing a cam and FIG. 12D is a perspective view showing a bolt;

FIG. 13A is a perspective view showing an insulating member assembly of the second connector portion of FIGS. 6A and 6B;

FIGS. 13B and 13C are perspective views showing a first insulating member of the insulating member assembly;

FIG. 14A is a perspective view showing the first insulating member and a second connecting terminal;

FIG. 14B is a perspective view showing the first insulating member, the second connecting terminal and the first connecting terminal;

FIG. 15A is a perspective view showing a first fitting detection terminal case and a first fitting detection terminal;

FIG. 15B is a perspective view showing the first fitting detection terminal;

FIG. 16A is a perspective view showing a second fitting detection terminal case, a second fitting detection terminal and a slide ring;

FIG. 16B is a perspective view showing the slide ring;

FIG. 16C is a perspective view showing the second fitting detection terminal;

FIGS. 17A to 17E are explanatory diagrams illustrating operation of a fitting detection mechanism; and

FIGS. 18A to 18C are explanatory diagrams illustrating operation of the fitting detection mechanism.

### DETAILED DESCRIPTION OF THE PREFERRED EMBODIMENTS

An embodiment of the invention will be described below in conjunction with the appended drawings.

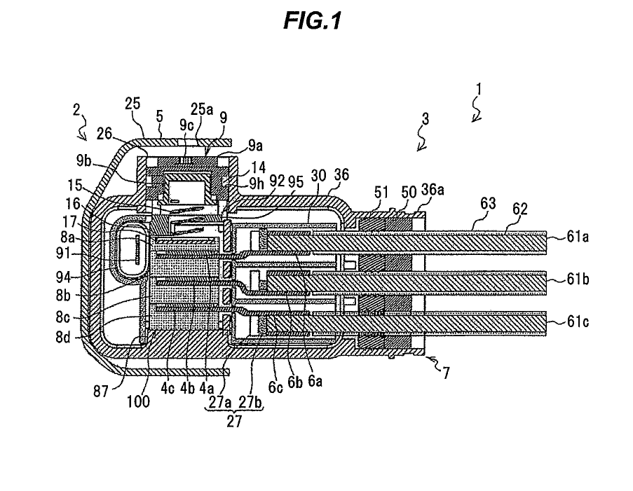

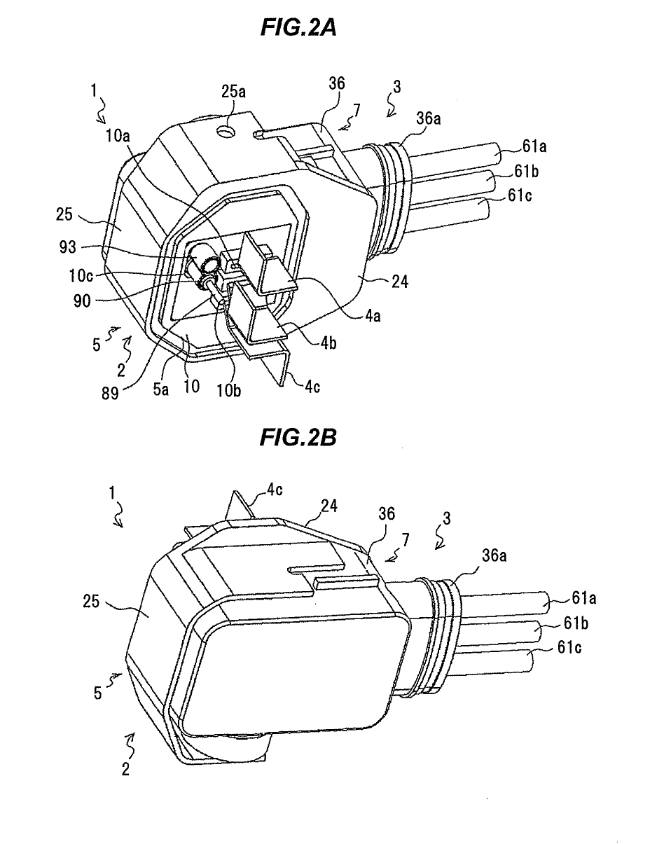

FIGS. 1 to 2B are diagrams illustrating a connector in the present embodiment, wherein FIG. 1 is a cross sectional view and FIGS. 2A and 2B are perspective views.

As shown in FIGS. 1 to 2B, a connector 1 in the present embodiment is composed of a first connector portion 2 and a second connector portion 3, and plural power lines are connected at a time by fitting the connector portions 2 and 3 together.

More specifically, the connector 1 is provided with the first connector portion 2 having a first terminal housing (male terminal housing) 5 housing plural (three) aligned first connecting terminals (male terminals) 4a to 4c, the second connector portion 3 having a second terminal housing (female terminal housing) 7 housing plural (three) aligned second connecting terminals (female terminals) 6a to 6c, and plural (four) insulating members 8a to 8d aligned and housed in the second terminal housing 7 for insulating the second connecting terminals 6a to 6c from each other.

The connector 1 is configured that, inside the first terminal housing 5 of the first connector portion 2 and the second terminal housing 7 of the second connector portion 3 which are fitted to each other, the first connecting terminals 4a to 4c and the second connecting terminals 6a to 6c are alternately arranged to form a laminated structure in which surfaces of the plural first connecting terminals 4a to 4c on one side face surfaces of the plural second connecting terminals 6a to 6c on one side to form respective pairs (a pair of the first connecting terminal 4a and the second connecting terminal 6a, that of the first connecting terminal 4b and the second connecting terminal 6b, and that of the first connecting terminal 4c and the second connecting terminal 6c) and to form plural contact points therebetween, and each contact point is sandwiched by two of the insulating members 8a to 8d.

In the connector 1, the first connector portion 2 is attached to a shielding case of a device such as inverter or motor and the externally exposed first connecting terminals 4a to 4c are electrically connected to the power lines of the device. Cables 61a to 61c are connected to the second connector portion 3, and are respectively electrically connected to the power lines of the device by connecting the first connector portion 2 to the second connector portion 3. The wire harness of the present embodiment is the cables 61a to 61c with the connector 1 (the second connector portion 3) provided at an end portion thereof.

The connector 1 is configured that the two terminal housings 5 and 7 are fitted so that a length direction of the first connecting terminals 4a to 4c crosses that of the second connecting terminals 6a to 6c. In the present embodiment, the connector 1 is configured that the two terminal housings 5 and 7 are fitted so that the length direction of the first connecting terminals 4a to 4c is orthogonal to that of the second connecting terminals 6a to 6c. Note that, in the connector 1, the length direction of the first connecting terminals 4a to 4c coincides with a fitting direction of the two terminal housings 5 and 7 and the length direction of the second connecting terminals 6a to 6c coincides with an extending direction of the cables 61a to 61c. Therefore, in the other words, the fitting direction of the two terminal housings 5 and 7 is orthogonal to the extending direction of the cables 61a to 61c.

It should be noted that, although a so-called L-shaped connector 1 in which the fitting direction of the two terminal housings 5 and 7 is orthogonal to the extending direction of the cables 61a to 61c will be described in the present embodiment, the invention is also applicable to a so-called straight connector in which the fitting direction of the two terminal housings 5 and 7 coincides with the extending direction of the cables 61a to 61c.

Each configuration of the connector portions 2 and 3 will be described in detail below.

First Connector Portion

Firstly, the first connector portion 2 will be described.

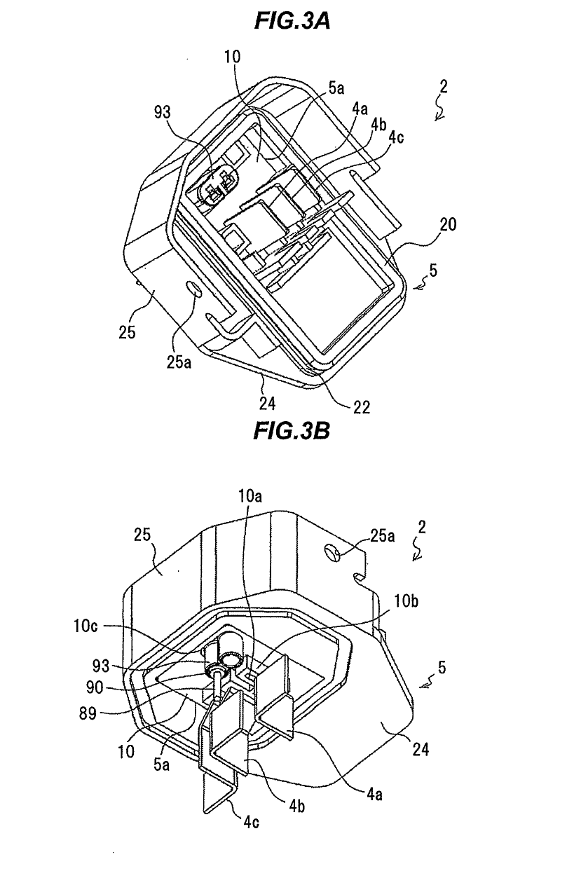

As shown in FIGS. 1 to 5, the first connector portion 2 is provided mainly with the first connecting terminals 4a to 4c, the first terminal housing 5 and a first inner housing 10.

Electricity of different voltage and/or current is transmitted to each of the first connecting terminals 4a to 4c. For example, the present embodiment assumes the use of a three-phase AC power line between a motor and an inverter, and alternate current having a phase difference of 120° is transmitted to each of the first connecting terminals 4a to 4c. Each of the first connecting terminals 4a to 4c should be formed of a highly conductive metal such as silver, copper or aluminum to reduce transmission loss, etc., in the connector 1. In addition, each of the first connecting terminals 4a to 4c has little flexibility.

For shielding performance, heat dissipation and weight saving of the connector 1, the first terminal housing 5 is preferably formed of light metal having high electrical and thermal conductivity such as aluminum, but may be formed of resin, etc. In the present embodiment, the first terminal housing 5 is formed of aluminum.

The first inner housing 10 is formed of an insulating resin (e.g., PPS (polyphenylene sulfide) resin, PPA (polyphthalamide) resin, PA (polyamide) resin, PBT (polybutylene terephthalate) and epoxy-based resin), etc.

The first connecting terminals 4a to 4c are respectively inserted into through-holes 10a formed on the first inner housing 10 and are then fixed. The first inner housing 10 is attached to the first terminal housing 5 so as to cover a terminal-attaching hole 5a formed on the first terminal housing 5, and the first connecting terminals 4a to 4c are thereby fixed to the first terminal housing 5 via the first inner housing 10 and are held in the first terminal housing 5 in the state of being aligned at predetermined intervals. Protruding portions 10b are provided on the first inner housing 10 so as to protrude outward from an rim of the through-holes 10a. This increases a contact area of the first inner housing 10 with the first connecting terminals 4a to 4c and it is thus possible to firmly hold the first connecting terminals 4a to 4c.

In addition, a first fitting detection terminal case-attaching hole 10c for attaching a below-described first fitting detection terminal case 93 is formed on the first inner housing 10.

The first terminal housing 5 is composed of a hollow cylindrical body 20 having a substantially rectangular horizontal cross-section and a lid portion 24 which is provided integrally with the cylindrical body 20 so as to cover one of openings of the cylindrical body 20 and has the terminal-attaching hole 5a formed thereon. The lid portion 24 is a flange-shaped portion to be in contact with a surface of the shielding case when the first connector portion 2 is attached to the shielding case of the device.

In the present embodiment, a protective wall 25 is formed so as to protrude forward in the fitting direction (toward the second connector portion 3) from an edge of the flange-shaped lid portion 24. A tool hole 25a is formed on the protective wall 25 to pass through a tool which is used for rotating a cam 9a of a blow-described connecting member 9.

The cylindrical body 20 is housed in the second terminal housing 7 when the two terminal housings 5 and 7 are fitted to each other. A groove 22 is formed on the outer periphery of the cylindrical body 20 along a circumferential direction and a packing (not shown) such as O-ring is placed in the groove 22 to make watertight between the second terminal housing 7 and the cylindrical body 20 when the two terminal housings 5 and 7 are fitted to each other. At an end portion of the cylindrical body 20 opposite to the lid portion 24, an edge on the outer peripheral side is formed in a tapered shape in light of fitting properties to the second terminal housing 7.

In the first terminal housing 5, the first connecting terminals 4a to 4c are arranged so as to be aligned in the thickness direction thereof.

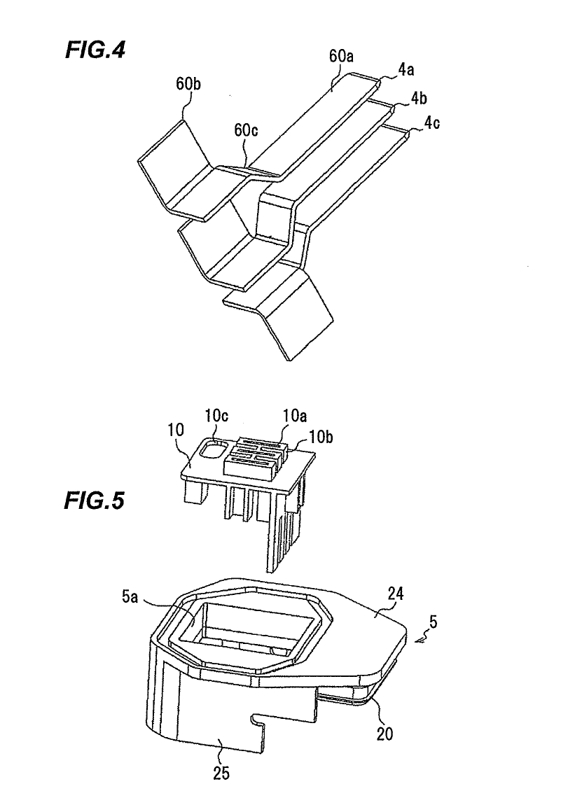

As shown in FIG. 4, each of the first connecting terminals 4a to 4c is configured such that an inclined portion 60c connects a base end portion of a plate-like member 60a to an L-shaped portion 60b formed in an L-shape as viewed from the fitting direction. The L-shaped portion 60b is provided so that one of two sides is parallel to a surface of the plate-like member 60a and is connected to the base end portion of the plate-like member 60a by the inclined portion 60c which is inclined with respect to the surface of the plate-like member 60a. Note that, the shape of the first connecting terminals 4a to 4c at a portion exposed to the outside from the first terminal housing 5 is not limited thereto and can be appropriately changed according to requirements on the device side. The tip portions of the first connecting terminals 4a to 4c are chamfered (or rounded) for easy insertion into a below-described insulating member assembly 100.

Second Connector Portion

Next, the second connector portion 3 will be described.

As shown in FIGS. 1 to 2B and 6A to 7B, the second connector portion 3 holds, inside thereof, three second connecting terminals 6a to 6c aligned at predetermined intervals, and is provided with the second terminal housing 7 housing the three aligned second connecting terminals 6a to 6c, plural insulating members 8a to 8d in a substantially rectangular parallelepiped shape which are provided in the second terminal housing 7 for insulating the second connecting terminals 6a to 6c from each other, and a connecting member 9 for collectively fixing and electrically connecting the plural first connecting terminals 4a to 4c to the plural second connecting terminals 6a to 6c at respective contact points by pressing the adjacent insulating member 8a.

The cables 61a to 61c are respectively connected to edges of the second connecting terminals 6a to 6c on one side. The cables 61a to 61c are each composed of a conductor 62 and an insulation layer 63 formed on the outer periphery thereof. The conductor 62 having a cross-sectional area of 20 mm² is used in the present embodiment.

Each of the second connecting terminals 6a to 6c should be formed of a highly conductive metal such as silver, copper or aluminum to reduce transmission loss, etc., in the connector 1. In addition, each of the second connecting terminals 6a to 6c has little flexibility.

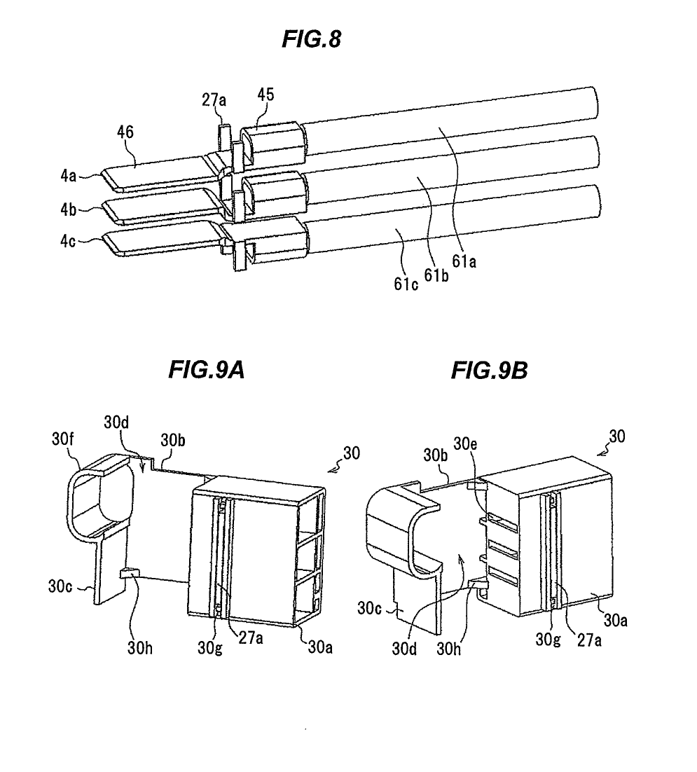

As shown in FIG. 8, each of the second connecting terminals 6a to 6c has a crimping portion 45 for crimping the conductor 62 exposed at a tip portion of each of the cables 61a to 61c and a plate-like member 46 integrally formed with the crimping portion 45, and is formed in a clamp shape by bending the plate-like member 46 at the base end portion (a connecting portion with the crimping portion 45) into an S-shape. Protrusions 27a are formed on the plate-like member 46 so as to protrude upward (downward) from both widthwise edges at the base end portion of the plate-like member 46. The protrusions 27a constitute a below described slip-off suppression mechanism 27. The tip portions of the second connecting terminals 6a to 6c are chamfered (or rounded) for easy insertion into the insulating members 8a to 8d.

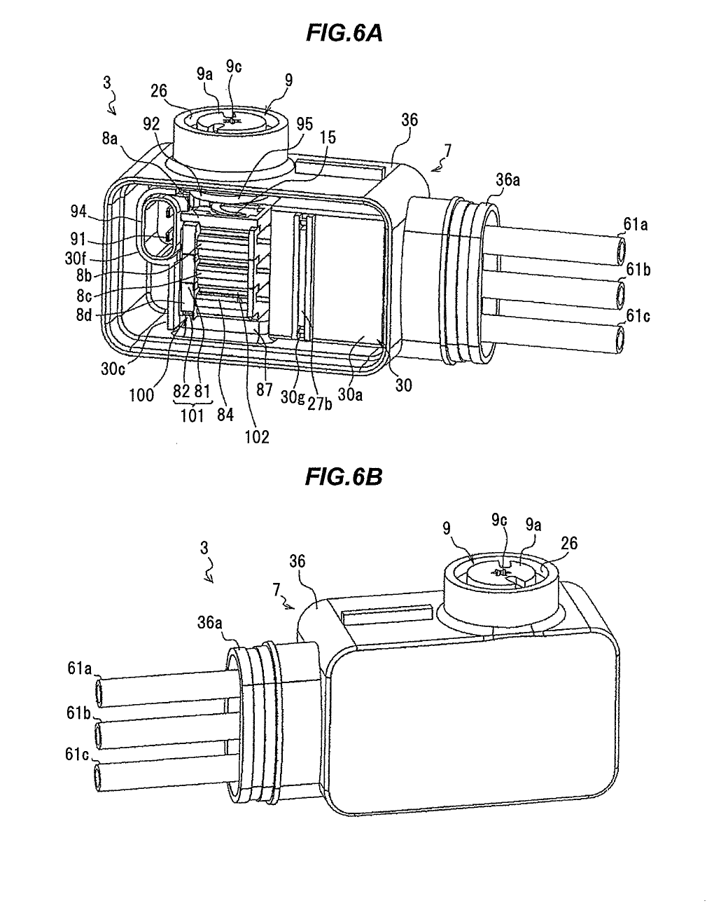

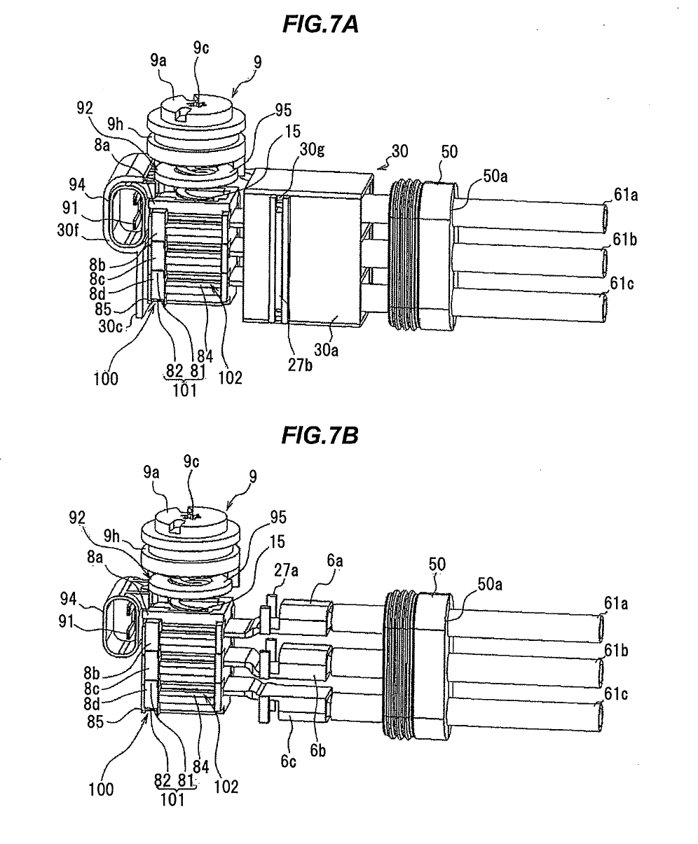

As shown in FIGS. 6A to 7B, a second inner housing 30, which is constructed from a resin molded article and has a multi-cylindrical shape (a shape formed of contiguous plural cylinders), holds the cables 61a to 61c so as to be aligned at predetermined intervals. The second connecting terminals 6a to 6c are fixed to the second terminal housing 7 via the cables 61a to 61c and the second inner housing 30. At this time, the second connecting terminals 6a to 6c are positioned and held respectively under (on the opposite side to the connecting member 9) the first connecting terminals 4a to 4c (i.e., connection targets) which respectively face and are paired with the second connecting terminals 6a to 6c when the first connector portion 2 is fitted to the second connector portion 3.

The second inner housing 30 is formed of an insulating resin (e.g., PPS (polyphenylene sulfide) resin, PPA (polyphthalamide) resin, PA (polyamide) resin, PBT (polybutylene terephthalate) and epoxy-based resin), etc., to prevent short circuit by insulating the second connecting terminals 6a to 6c from each other. The second inner housing 30 allows the second connecting terminals 6a to 6c to be held at respective predetermined positions even when each of the cables 61a to 61c respectively connected to the second connecting terminals 6a to 6c is very flexible. In other words, since a cable excellent in flexibility can be used as the cables 61a to 61c in the present embodiment, it is possible to improve the wiring flexibility for laying the cables 61a to 61c.

As shown in FIG. 9, the second inner housing 30 is formed in a multi-cylindrical shape composed of three contiguous square cylinders each opened on one side, has a main body 30a formed in a rectangular parallelepiped shape as a whole, a plate-like parallel portion 30b extending from a side edge portion of the main body 30a in an insertion direction of the cables 61a to 61c and a plate-like vertical portion 30c orthogonally extending from the front edge of the parallel portion 30b, and is configured that the insulating members 8a to 8d are housed in a space 30d which is surrounded by the parallel portion 30b, the vertical portion 30c and a surface of the main body 30a on the front side in the insertion direction of the cables 61a to 61c.

Reinforcing ribs 30h are respectively formed at a corner formed at an intersection of the parallel portion 30b and the surface of the main body 30a on the front side in the insertion direction of the cables 61a to 61c and at a corner formed at an intersection of the vertical portion 30c and the parallel portion 30b. In addition, a case housing portion 30f for slidably housing a below-described second fitting detection terminal case 94 is formed on the vertical portion 30c. The case housing portion 30f is formed in a cylindrical shape of which lateral side is partially opened (on the main body 30a side).

Terminal insertion holes 30e for inserting the second connecting terminals 6a to 6c (for exposing the tip portions of the second connecting terminals 6a to 6c from the main body 30a) are formed on the surface of the main body 30a on the front side in the insertion direction of the cables 61a to 61c.

Although the second connecting terminals 6a to 6c in the present embodiment are inserted into the terminal insertion holes 30e so that the second connecting terminals 6a to 6c are directly held by the second inner housing 30 and are positioned, it is not limited thereto. It is also possible to position the second connecting terminals 6a to 6c by holding the cables 61a to 61c (in more detail, by holding the end portion of the cables 61a to 61c at a position close to the second connecting terminals 6a to 6c). Note that, it is preferable that the terminal insertion hole 30e be formed slightly larger than the second connecting terminals 6a to 6c so that the second connecting terminals 6a to 6c which are deformed by being pressed by the connecting member 9 do not come into contact with the second inner housing 30.

The second connector portion 3 is provided with the slip-off suppression mechanism 27 so that the cables 61a to 61c are not pulled out from the second inner housing 30 even when the cables 61a to 61c are pulled. The slip-off suppression mechanism 27 is composed of the protrusions 27a formed at the respective base end portions of the second connecting terminals 6a to 6c (in the vicinity of the cables 61a to 61c; in the present embodiment, at an end portion of the plate-like member 46 on the crimping portion 45 side), and an inner plate 27b for locking the protrusions 27a to restrict the protrusions 27a from moving backward (toward the cables 61a to 61c) (see FIG. 1). An inner plate insertion hole 30g is formed on a side surface of the main body 30a (a side surface facing the opening of the second terminal housing 7) and the inner plate 27b is inserted therethrough so as to protrude into each of the multiple cylinders after the cables 61a to 61c and the second connecting terminals 6a to 6c are inserted into the main body 30a of the second inner housing 30, thereby providing the inner plate 27b. Note that, the structure of the inner plate 27b is not limited in the present embodiment and any structure is acceptable as long as the protrusions 27a of the second connecting terminals 6a to 6c are locked and movement of the protrusions 27a is restricted.

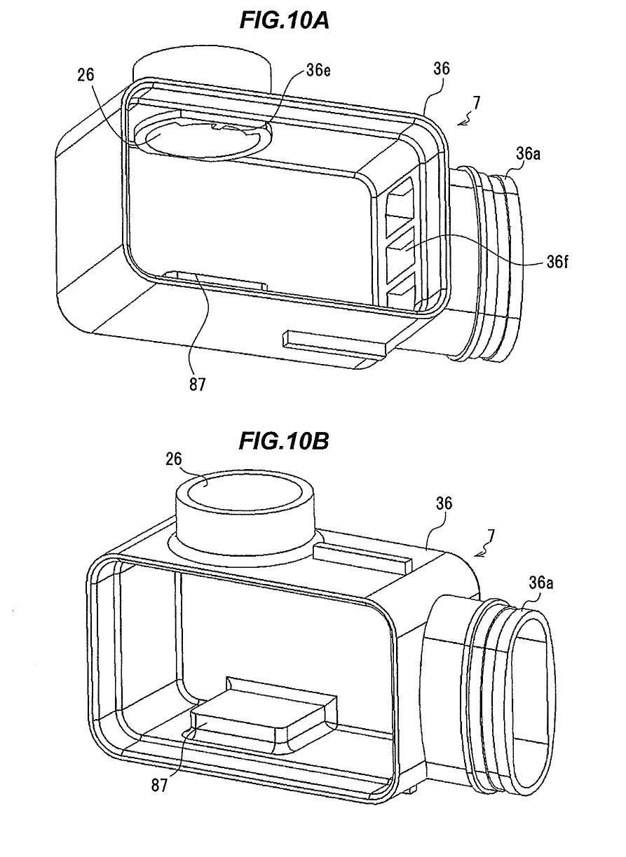

As shown in FIGS. 1, 6A, 6B, 10A and 10B, the second terminal housing 7 is constructed from a hollow cylindrical body 36 opening on one side and having a substantially rectangular cross section, and is configured that the first terminal housing 5 is inserted and fitted to the opening of the cylindrical body 36. A cylindrical cable insertion portion 36a for inserting the cables 61a to 61c is formed integrally on the lateral side of the cylindrical body 36 (the side surface on the right side in FIGS. 10A and 10B). A hollow portion in the cylindrical body 36 is in communication with that in the cable insertion portion 36a via three rectangular insertion holes 36f for passing the cables 61a to 61c, and the cables 61a to 61c pass through the hollow portion in the cable insertion portion 36a and the insertion holes 36f and are then inserted into the cylindrical body 36. The insertion direction of the first terminal housing 5 is orthogonal to the insertion direction of the cables 61a to 61c.

A braided shield may be wound around the cables 61a to 61c led out of the second terminal housing 7 in order to improve the shielding performance even though it is not illustrated. For example, the braided shield is electrically connected to the first terminal housing 5 via the second terminal housing 7 and is kept at ground potential.

Furthermore, the outer periphery of the cable insertion portion 36a from where the cables 61a to 61c are led out is covered by a rubber boot for preventing water from entering into the cable insertion portion 36a or the cylindrical body 36, even though it is not illustrated.

Meanwhile, a connecting member insertion hole 26 for inserting the connecting member 9 is formed on an upper portion of the cylindrical body 36 (on the upper side in FIG. 10). The second terminal housing 7 is formed to have a cylindrical shape (hollow cylinder) at the rim of the connecting member insertion hole 26.

A rectangular parallelepiped-shaped pedestal 87 protruding toward the connecting member insertion hole 26 is provided on an inner peripheral surface of the cylindrical body 36 at a position facing the connecting member insertion hole 26. In the connector 1, the laminated structure is sandwiched and held between the connecting member 9 and the pedestal 87, and a pressing force is applied to the laminated structure by pressing the connecting member 9 toward the pedestal 87 and is thereby applied to each contact point.

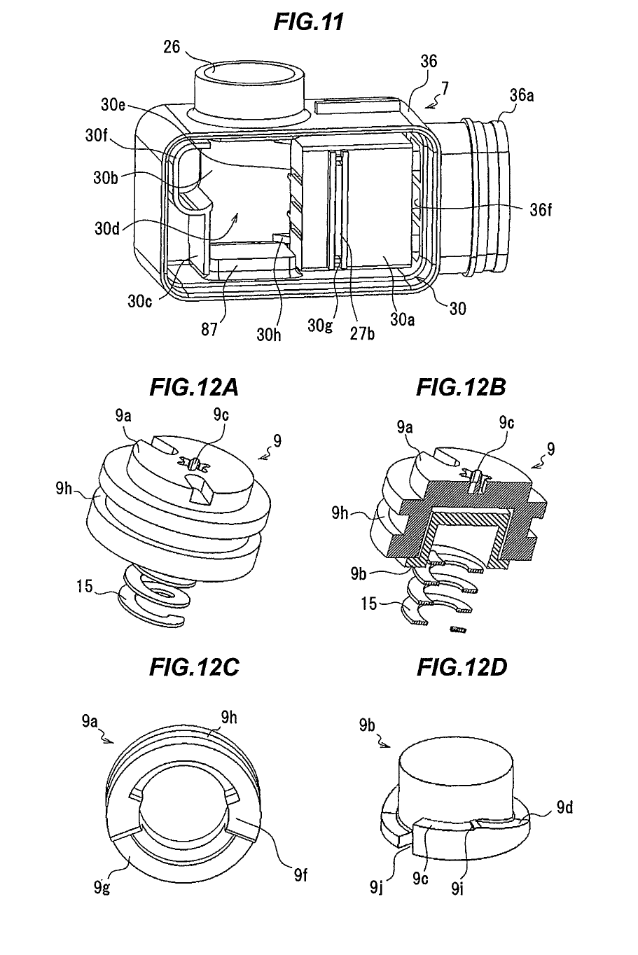

As shown in FIG. 11, the second inner housing 30 is arranged so that the main body 30a is arranged next to the pedestal 87 on the cable insertion portion 36a side, the parallel portion 30b extends over the pedestal 87 and the vertical portion 30c is located on a side of the pedestal 87 opposite to the cable insertion portion 36a.

For shielding performance, heat dissipation and weight saving of the connector 1, the second terminal housing 7 is preferably formed of light metal having high electrical and thermal conductivity such as aluminum, but may be formed of resin, etc. In the present embodiment, the cylindrical body 36 is formed of aluminum.

In addition, in the second connector portion 3, the cables 61a to 61c are sandwiched and held by a tail plate 50 having a two-divided structure provided with holes 50a for inserting the cables 61a to 61c as shown in FIGS. 7A and 7B and a wire seal (waterproof packing) 51 is provided next to the tail plate 50 on the second connecting terminals 6a to 6c side, which keeps water from entering the second terminal housing 7 along the cables 61a to 61c. The wire seal 51 is arranged so as to be sandwiched between the tail plate 50 and the wall in the periphery of the insertion holes 36f (see FIG. 10A).

As shown in FIGS. 1 and 6A to 7B, among the plural insulating members 8a to 8d, the plural first insulating members 8b to 8d are aligned and housed in the second terminal housing 7 and are also provided integrally with the respective surfaces of the plural second connecting terminals 6a to 6c on another side (surfaces opposite to the surfaces connected to the first connecting terminals 4a to 4c), and a second insulating member 8a is provided so as to face the surface of the outermost first connecting terminal 4a (the uppermost side in FIGS. 1 and 6A to 7B) on another side (a surface opposite to the surface connected to the second connecting terminal 6a) when the plural first connecting terminals 4a to 4c and the plural second connecting terminals 6a to 6c form a laminated state.

In the connector 1 of the present embodiment, the insulating member assembly 100, which has an insulating member restricting means 101 for restricting movement of the insulating members 8a to 8d in a direction perpendicular to a lamination direction of the laminated structure, is formed by connecting the insulating members 8a to 8d to each other. The insulating member restricting means 101 is configured to restrict movement of the insulating members 8a to 8d in the x-y plane of the orthogonal coordinate system in which the lamination direction of the laminated structure is the z-axis.

Holes for inserting the connecting terminals 4a to 4c and 6a to 6c to be inserted orthogonal to each other, i.e., first terminal insertion holes 102 for inserting the first connecting terminals 4a to 4c and second terminal insertion holes 103 for inserting the second connecting terminals 6a to 6c, are provided on the insulating member assembly 100. The first terminal insertion hole 102 is formed between adjacent two of the insulating members 8a to 8d and the second terminal insertion hole 103 is formed on each of the first insulating members 8b to 8d. The insulating member assembly 100 will be described in detail later.

As shown in FIG. 12, the connecting member 9 is composed of the cam 9a and a bolt 9b. The cam 9a is formed in a cylindrical shape opening only on the lower side and has an irregular-shaped hole 9c (in the present embodiment, a hole having a hexalobular shape) formed on an upper surface so that a tool such as wrench can be fitted to rotate the cam 9a. On the side surface of the cam 9a, a groove 9h is formed to house a packing 14 (see FIG. 1) such as O-ring which is provided to keep water from entering the second terminal housing 7. The lower portion of the cam 9a (including a position for forming the groove 9h) has an enlarged diameter having a flange shape. Although it is not illustrated, it is configured that, when inserting the cam 9a into the connecting member insertion hole 26 of the second terminal housing 7 and fitting and fixing a ring-shaped fixing member into a groove formed on the inner peripheral surface of the connecting member insertion hole 26, the flange portion which comes into contact with the fixing member restricts movement of the cam 9a toward the outside and the cam 9a is thus rotatably held between the second terminal housing 7 and the fixing member.

An upper portion of the bolt 9b is inserted into the hollow portion in the cam 9a. Raised portions 9f protruding toward the hollow portion are formed on the inner wall (inner peripheral surface) of the hollow portion in the cam 9a at positions facing each other. In addition, a cut-out portion 9g is formed by cutting off a circumferential portion of the sidewall of the cam 9a at a lower end (an end portion on the second insulating member 8a side). The cut-out portion 9g is to be engaged with an engaging wall 95c of a below-described slide ring 95.

The bolt 9b is formed in a cylindrical shape opening only on the lower side and has a flange-like enlarged diameter at the lower portion thereof. A notch 9j formed on the flange portion is slidably engaged with a linear protrusion 36e (see FIG. 10A) formed on the second terminal housing 7 so as to extend vertically, which allows the bolt 9b to slide in a vertical direction without rotating together with the cam 9a.

Slopes 9d are formed on the upper surface of the flange portion (i.e., a stepped portion) of the bolt 9b. The two slopes 9d are formed at 180° rotationally symmetric positions around a rotational axis of the cam 9a so as to correspond to the two raised portions 9f. A flat portion 9e is formed at the top of the slope 9d and a level difference 9i is formed between the flat portion 9e and the slope 9d to restrict the raised portion 9f located on the flat portion 9e from moving and thus to prevent unintentional rotation of the cam 9a.

The connecting member 9 is configured that, when the cam 9a is rotated in the tightening direction from the release position, the raised portions 9f of the cam 9a come into contact with the slopes 9d of the bolt 9b and moves the bolt 9b toward the second insulating member 8a and the second insulating member 8a is thereby pressed. Due to such a configuration, the cam 9a to be rotated by a worker is always located at a certain position and does not move vertically, which improves workability. Hereinafter, a rotation direction of the cam 9a for applying a pressing force to each contact point will be referred to as “the tightening direction” and a rotation direction of the cam 9a for releasing a pressing force applied to each contact point will be referred to as “the direction opposite to the tightening direction”.

The cam 9a and the bolt 9b which are formed of a metal such as SUS, iron or copper alloy are used. The cam 9a and the bolt 9b may be formed of a resin but are preferably formed of metal from the viewpoint of strength.

Meanwhile, an elastic member 15 for applying a predetermined pressing force to the second insulating member 8a is provided between the bolt 9b of the connecting member 9 and the upper surface of the second insulating member 8a immediately therebelow. In the present embodiment, the upper portion of the elastic member 15 is housed in the hollow portion in the bolt 9b. This is an idea to reduce a distance between the bolt 9b and the second insulating member 8a and to downsize the connector 1 even when the elastic member 15 is long to some extent. The elastic member 15 is constructed from, e.g., a spring formed of metal (e.g., SUS, etc.). Note that, the elastic member 15 is regarded as a portion of the connecting member 9 in the present embodiment.

A concave portion 16 (see FIGS. 7A and 7B) covering (housing) a lower portion of the elastic member 15 is formed on the upper surface of the second insulating member 8a with which the lower portion of the elastic member 15 is in contact, and a receiving member 17 formed of metal (e.g., SUS, etc.) for preventing the second insulating member 8a formed of an insulating resin from being damaged by receiving the elastic member 15 is provided on a bottom of the concave portion 16 (i.e., a seat portion with which the lower portion of the elastic member 15 is in contact).

The receiving member 17 is to prevent damage on the second insulating member 8a by dispersing stress applied from the elastic member 15 to the upper surface of the second insulating member 8a. Therefore, a contact area between the receiving member 17 and the second insulating member 8a is preferably as large as possible. The receiving member 17 having a shape in contact throughout the entire bottom surface of the concave portion 16 is provided in the present embodiment in order to increase the contact area between the receiving member 17 and the second insulating member 8a.

Connection Between First Connector Portion and Second Connector Portion

When the two terminal housings 5 and 7 are fitted to each other, the first connecting terminals 4a to 4c are respectively inserted into the first terminal insertion holes 102 and are then inserted into respective gaps between the second connecting terminals 6a to 6c to be respectively paired therewith and the insulating members 8a to 8d. This insertion provides a laminated structure in which the surfaces of the plural first connecting terminals 4a to 4c on the one side face the surfaces of the plural second connecting terminals 6a to 6c on the one side to form the respective pairs, and the first connecting terminals 4a to 4c, the second connecting terminals 6a to 6c and the insulating members 8a to 8d are alternately arranged, i.e., the insulating members 8a to 8d are arranged so as to sandwich the pairs of the first connecting terminals 4a to 4c and the second connecting terminals 6a to 6c.

At this time, in the second connector portion 3, since the first insulating members 8b to 8d are respectively provided at the tips of the second connecting terminals 6a to 6c aligned and held at predetermined intervals, each gap between the insulating members 8b to 8d can be kept without additionally providing a retaining jig for keeping respective gaps between the insulating members 8b to 8d. This makes easy to insert the first connecting terminals 4a to 4c into the respective gaps between the second connecting terminals 6a to 6c to be respectively paired therewith and the insulating members 8a to 8d. In other words, the insertion and extraction properties of the first connecting terminals 4a to 4c are not degraded. In addition, it is very effective in that it is possible to realize further downsizing as compared to the conventional art since it is not necessary to provide a retaining jig for keeping the gaps between the insulating members 8b to 8d.

Meanwhile, a contact point between the first connecting terminal 4a and the second connecting terminal 6a is sandwiched between the second insulating member 8a and the first insulating member 8b attached to the second connecting terminal 6a constituting the contact point. Likewise, a contact point between the first connecting terminal 4b (or 4c) and the second connecting terminal 6b (or 6c) is sandwiched between the first insulating member 8c (or 8d) attached to the second connecting terminal 6b (or 6c) constituting the contact point and the first insulating member 8b (or 8c) attached to the second connecting terminal 6a (or 6b) constituting another contact point.

When the cam 9a of the connecting member 9 is turned by a tool such as wrench in this state and presses the bolt 9b downward, the second insulating member 8a, the first insulating member 8b, the first insulating member 8c and the first insulating member 8d are pressed in this order by the elastic member 15, a pressing force is applied to each contact point by any two of the insulating members 8a to 8d sandwiching and pressing each contact point to cause contact in a state that contact points are insulated from each other. At this time, the first connecting terminals 4a to 4c and the second connecting terminals 6a to 6c are bent in some degree due to pressure from the insulating members 8a to 8d and respectively make contact in a large area. This makes strong contact and fixation of each contact point even under the environment in which vibration occurs, such as in a vehicle.

A tool for rotating the cam 9a is fitted to the irregular-shaped hole 9c through the tool hole 25a on the protective wall 25. The connector 1 is configured that the irregular-shaped hole 9c is out of alignment with the tool hole 25a and the cam 9a cannot be rotated by the tool when the two terminal housings 5 and 7 are not tightly fitted to each other, and that a pressing force is applied to each contact point only when the two terminal housings 5 and 7 are firmly fitted to each other.

Insulating Member Assembly

Next, the insulating member assembly 100 will be described in detail.

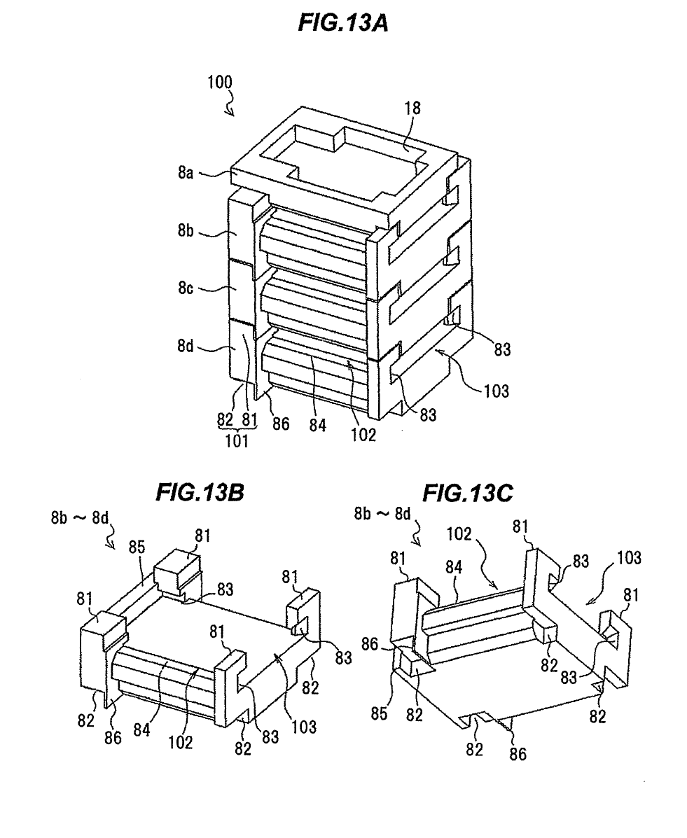

As shown in FIGS. 1, 7A, 7B and 13A to 13C, the insulating member assembly 100 is formed by sequentially connecting the insulating members 8a to 8d in the lamination direction. That is, the insulating member assembly 100 is formed by respectively connecting the second insulating member 8a to the first insulating member 8b, the first insulating member 8b to the first insulating member 8c, and the first insulating member 8c to the first insulating member 8d.

In the insulating member assembly 100, the insulating member restricting means 101 restricts the insulating members 8a to 8d from moving in the lamination direction and the vertical direction when the insulating members 8a to 8d are connected to each other. In the insulating member assembly 100, the insulating members 8a to 8d are connected to be relatively movable in the lamination direction in order to transfer a pressing force of the connecting member 9 to each contact point.

The insulating member restricting means 101 is provided with plural connecting pieces 81 and plural connecting grooves 82. The connecting pieces 81 are provided one of the two insulating members 8a, 8b, 8c or 8d adjacent in the lamination direction and protrude toward the other adjacent insulating member 8a, 8b, 8c or 8d. The connecting grooves 82 are provided on the other adjacent insulating member 8a, 8b, 8c or 8d so as to correspond to the plural connecting pieces 81 and receive the connecting pieces 81 so as to be slidable in the lamination direction.

In the present embodiment, the insulating members 8a to 8d are formed in a substantially rectangular shape as viewed from the lamination direction thereof and one or both of the connecting piece 81 and the connecting groove 82 are formed at least at two of four corners of the insulating members 8a to 8d. Here, the case where one or both of the connecting piece 81 and the connecting groove 82 are formed at four corners of the insulating members 8a to 8d will be described.

In insulating member assembly 100, the connecting pieces 81 are integrally formed on the first insulating members 8b to 8d so as to extend from four corners in the width direction of the first insulating members 8b to 8d toward the opposite insulating members 8a to 8c (toward the second insulating member 8a from the first insulating member 8b, toward the first insulating member 8b from the first insulating member 8c and toward the first insulating member 8c from the first insulating member 8d) with interposition of the second connecting terminals 6a to 6c to which the first insulating members 8b to 8d are attached.

In addition, the connecting grooves 82 for receiving the connecting pieces 81 so as to be slidable in the lamination direction are respectively formed on the both side surfaces of the insulating members 8a to 8c opposite to the first insulating members 8b to 8d (facing with interposition of the second connecting terminals 6a to 6c to which the first insulating members 8b to 8d are attached). In the present embodiment, the plural first insulating members 8b to 8d are formed to have the same shape and the connecting grooves 82 are also formed on the first insulating members 8d which is located at the outermost position. In addition, in the present embodiment, the connecting piece 81 and the connecting groove 82 are formed in a substantially rectangular shape as viewed from the lamination direction. Forming the plural first insulating members 8b to 8d into the same shape allows the number of components and the cost to be reduced.

The insulating members 8a to 8d are connected to be relatively movable in the lamination direction by respectively receiving the connecting pieces 81 of the first insulating member 8b in the connecting grooves 82 of the second insulating member 8a, the connecting pieces 81 of the first insulating member 8c in the connecting grooves 82 of the first insulating member 8b and the connecting pieces 81 of the first insulating member 8d in the connecting grooves 82 of the first insulating member 8c, and the insulating member assembly 100 is thereby formed.

In addition, the insulating member assembly 100 is configured that, when the insulating members 8a to 8d are connected (laminated), the front edge (top edge) of the connecting piece 81 is stopped by the upper surface of the connecting groove 82 and each gap between the insulating members 8a to 8d is controlled so as not to be narrower than a predetermined gap (the minimum lamination gap).

The minimum lamination gap is adjusted to be slightly smaller than the total thickness (contact point thickness) of the first connecting terminal 4a, 4b or 4c and the second connecting terminal 6a, 6b or 6c which constitute a contact point. It is because a pressing force from the connecting member 9 is not transferred to the contact point if the minimum lamination gap is greater than the contact point thickness and if, on the other hand, the minimum lamination gap is too small, the positional misalignment of the insulating members 8a to 8d become too large when the second connecting terminals 6a to 6c are deformed for some reasons and this causes defects such as deterioration in fitting properties. The minimum lamination gap can be adjusted by adjusting a difference in length in the lamination direction between the connecting piece 81 and the connecting groove 82 (for example, the minimum lamination gap is increased with increasing the length of the connecting piece 81 with respect to the connecting groove 82).

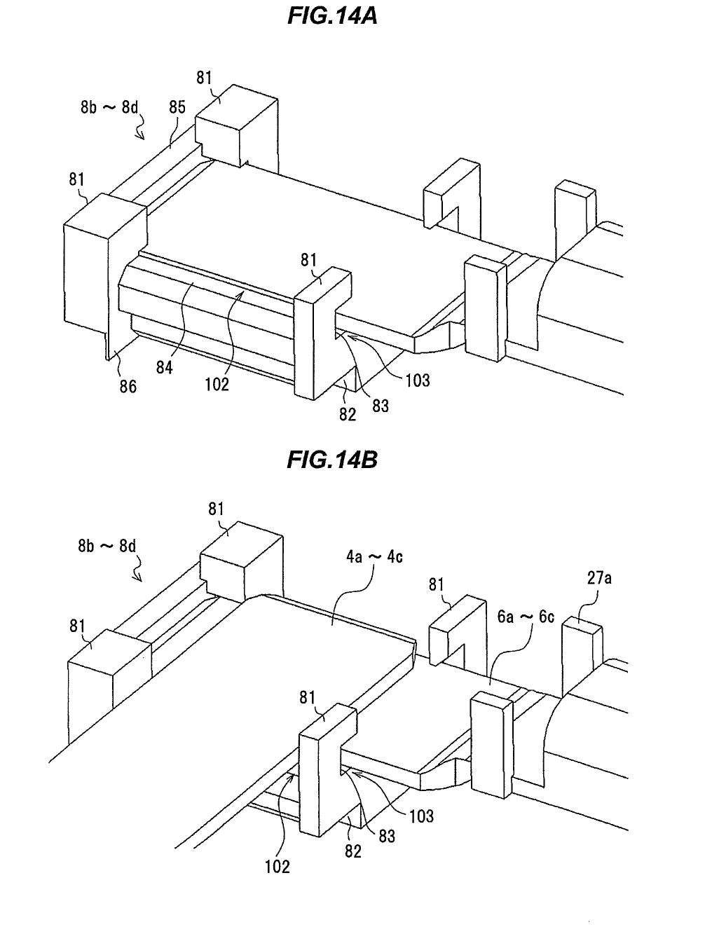

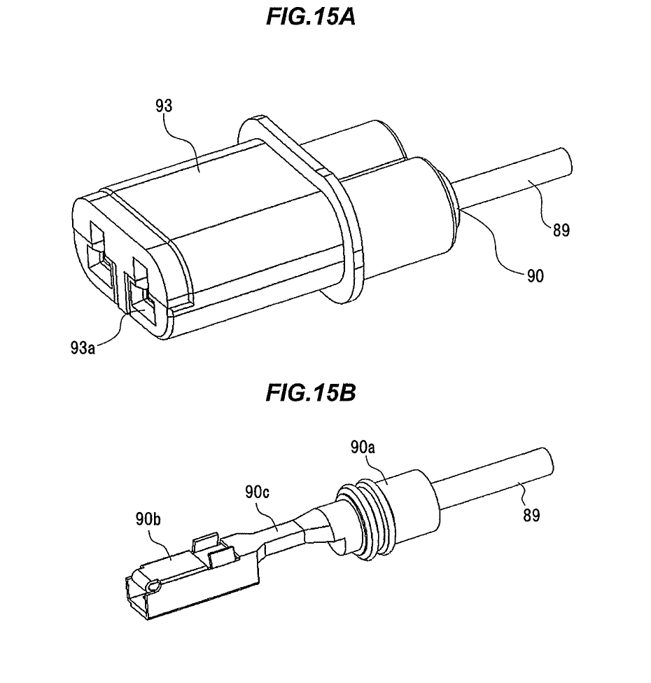

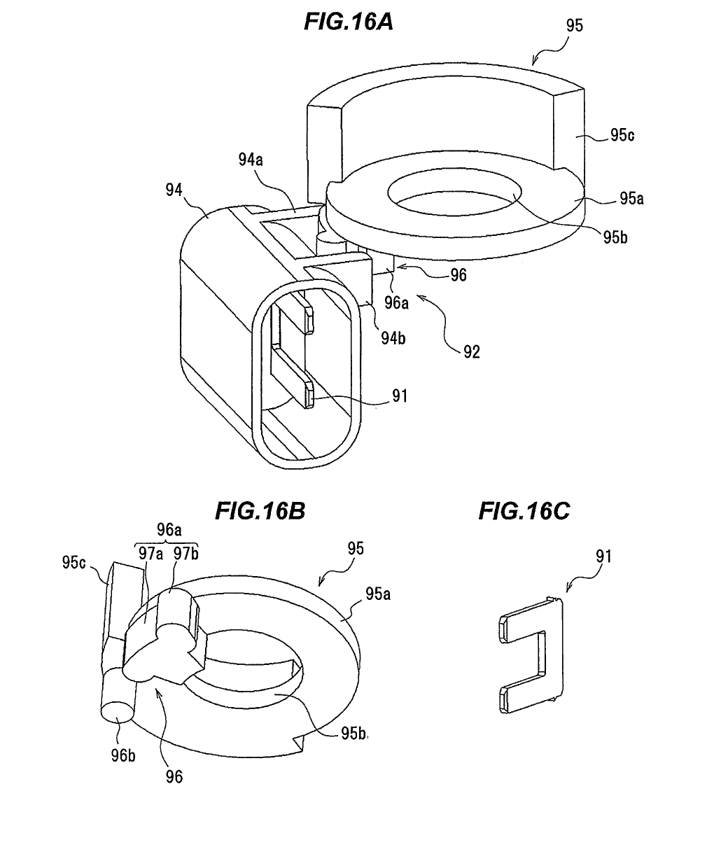

As shown in FIG. 14A, the four connecting pieces 81 of the first insulating members 8b to 8d are formed in a substantially F-shape or a substantially mirror-reversed Γ-shape as viewed from the length direction of the second connecting terminals 6a to 6c, and a squared U-shaped fitting groove 83 opening inward is formed on each connecting piece 81. The first insulating members 8b to 8d are locked and fixed to the second connecting terminals 6a to 6c by inserting the second connecting terminals 6a to 6c into the fitting grooves 83. In other words, the connecting piece 81 has a function of connecting the insulating members 8a to 8d to each other as well as a function of locking the second connecting terminals 6a to 6c, and the fitting grooves 83 of the connecting pieces 81 serve as the second terminal insertion hole 103.

On the other hand, as shown in FIG. 1 and FIG. 14B, the first connecting terminals 4a to 4c are inserted between the connecting pieces 81 which are formed at positions facing the opening of the second terminal housing 7 (on a side from which the first connecting terminals 4a to 4c are inserted) when the two terminal housings 5 and 7 are fitted to each other. In other words, the connecting pieces 81 formed at the positions facing the opening of the second terminal housing 7 also have a function of guiding and positioning the tip portions of the first connecting terminals 4a to 4c, and an opening sandwiched by the two connecting pieces 81 between the second connecting terminal 6a, 6b or 6c and the insulating member 8a, 8b or 8c serves as the first terminal insertion hole 102.

In the present embodiment, as shown in FIGS. 14A and 14B, a collision-prevention wall 84 is integrally formed on each of the plural first insulating members 8b to 8d. The collision-prevention wall 84 covers an end face of the second connecting terminal 6a, 6b or 6c on the side from which the first connecting terminals 4a to 4c are inserted, in order to prevent collision between the two connecting terminals 4a, 4b or 4c and 6a, 6b or 6c at the time of inserting the first connecting terminal 4a, 4b or 4c between the second connecting terminal 6a, 6b or 6c and the insulating member 8a, 8b or 8c. An edge of each collision-prevention wall 84 is chamfered (or rounded) to facilitate insertion of the first connecting terminals 4a to 4c. A portion of each of the insulating members 8a to 8c at a position facing the collision-prevention wall 84 (i.e., an edge of the each of the insulating members 8a to 8c on the opposite side to the connecting member 9 and on the side from which the first connecting terminals 4a to 4c are inserted) is also chamfered (or rounded) in the same manner. An edge of the connecting piece 81 on the first terminal insertion hole 102 side may be also chamfered or rounded to further facilitate insertion of the first connecting terminals 4a to 4c even though it is not performed in the present embodiment. The collision-prevention wall 84 is formed so that the upper surface thereof is flush with the upper surface of the second connecting terminal 6a, 6b or 6c.

Since the first insulating members 8b to 8d is attached to the second connecting terminals 6a to 6c, the first insulating members 8b to 8d are held by the second terminal housing 7 via the second connecting terminals 6a to 6c and the second inner housing 30 and are positioned with respect to the first terminal housing 5. In the state that the first insulating members 8b to 8d are positioned with respect to the first terminal housing 5, a gap is formed between the front edge of the connecting piece 81 and the upper surface of the connecting groove 82 and the first insulating members 8b to 8d are relatively movable to each other in the lamination direction. At this time, the insulating members 8a to 8d are housed in the space 30d surrounded by the main body 30a, the parallel portion 30b and the vertical portion 30c of the second inner housing 30 (see FIGS. 9 and 11).

The fitting groove 83 is formed so that a width thereof in the lamination direction is slightly larger than the thickness of the second connecting terminals 6a to 6c. Thus, a gap (or clearance) is formed between the fitting groove 83 and the second connecting terminal 6a, 6b or 6c when the second connecting terminal 6a, 6b or 6c is fitted to the fitting groove 83. Accordingly, the first insulating members 8b to 8d are provided having looseness with respect to the second connecting terminals 6a to 6c. Since the first insulating members 8b to 8d are provided having looseness with respect to the second connecting terminals 6a to 6c, the first insulating members 8b to 8d can flexibly move even when the first insulating members 8b to 8d are slightly out of alignment. Therefore, deterioration in fitting properties such as hitting of the first connecting terminals 4a to 4c against the first insulating members 8b to 8d can be suppressed. In addition, forming the gaps (or clearances) between the fitting grooves 83 and the second connecting terminals 6a to 6c allows the second connecting terminals 6a to 6c to be easily fitted to the fitting grooves 83. Note that, although only the lateral edge of the fitting groove 83 is chamfered in the present embodiment in order to easily fit the second connecting terminal 6a, 6b or 6c into the fitting grooves 83, the upper and lower edges of the fitting groove 83 or an edge of the first insulating members 8b to 8d on the side from which the second connecting terminals 6a to 6c are inserted may be chamfered or rounded.

In addition, a connecting wall 85 is integrally formed on each of the first insulating members 8b to 8d so as to connect between the two connecting pieces 81 located opposite to the side from which the second connecting terminals 6a to 6c are inserted. The connecting wall 85 is provided parallel to the insertion direction of the first connecting terminals 4a to 4c so as to cover a side of the fitting groove 83 opposite to the side from which the second connecting terminals 6a to 6c are inserted, which improves mechanical strength of the connecting pieces 81. In addition, the tip portions of the second connecting terminals 6a to 6c hit against the connecting walls 85. Therefore, the connecting wall 85 serves to position the second connecting terminals 6a to 6c and to suppress excessive insertion thereof. Furthermore, the connecting wall 85 extends downward so as to cover a side of the connecting groove 82 opposite to the side from which the second connecting terminals 6a to 6c are inserted. This increases a contact area when the connecting piece 81 is inserted into the connecting groove 82. Thus, the connecting wall 85 also has a function of further stabilizing the connection between the first insulating members 8b to 8d to each other. Note that, the connecting wall 85 is formed at a height that does not hit the opposite insulating member 8a, 8b or 8c when each gap between the insulating members 8a to 8d is set to the minimum lamination gap.

Furthermore, as shown in FIG. 14B, the connecting wall 85 covers the lateral side of the first connecting terminal 4a, 4b or 4c and serves to increase a creepage distance between the contact points when the two terminal housings 5 and 7 are fitted and the first connecting terminals 4a to 4c are inserted. Such a configuration is effective especially when reducing the size of the insulating members 8a to 8d to downsize the connector 1. Note that, in the present embodiment, a connecting wall is not formed on a side of the insulating members 8a to 8d opposite to the side from which the first connecting terminals 4a to 4c are inserted since it is configured that the first connecting terminals 4a to 4c are inserted partway without covering the entire second connecting terminals 6a to 6c when the two terminal housings 5 and 7 are fitted and this increases the creepage distance between the contact points via the side of the insulating members 8b to 8d opposite to the side from which the first connecting terminals 4a to 4c are inserted, however, it is obviously possible to further form a connecting wall on the side of the insulating members 8b to 8d opposite to the side from which the first connecting terminals 4a to 4c are inserted.

In addition, in the present embodiment, a reinforcing wall 86 is provided so as to face the connecting wall 85 with the connecting groove 82 interposed therebetween and it is configured that sandwiching the connecting piece 81 inserted into the connecting groove 82 between the connecting wall 85 and the reinforcing wall 86 allows the connecting piece 81 to be held more firmly.

Although the connecting pieces 81 are formed on the first insulating members 8b to 8d and the connecting grooves 82 are formed on the opposite insulating members 8a to 8c in the present embodiment, it is obviously possible to reverse the positions of the connecting pieces 81 and the connecting grooves 82 in the insulating member assembly 100 (to form the connecting pieces 81 on the insulating members 8a to 8c and the connecting grooves 82 on the opposite insulating members 8b to 8d). In this case, however, it is not possible to form the fitting groove 83 on the connecting piece 81 and a mechanism for providing the first connecting terminals 4a to 4c needs to be additionally provided on the first insulating members 8b to 8d, which makes the structure of the first insulating members 8b to 8d complicated.

Fitting Detection Mechanism

Next, a fitting detection mechanism which is an essential part of the invention will be described.

The connector 1 is provided with a fitting detection mechanism for detecting the fitting of the two terminal housings 5 and 7. The fitting detection mechanism constitutes a part of a current interrupting device such as High Voltage Interlock Loop (HVIL).

The fitting detection mechanism is provided with a first fitting detection terminal 90 provided on one of the first terminal housing 5 and the second terminal housing 7, a second fitting detection terminal 91 provided on the other of the first terminal housing 5 and the second terminal housing 7 so as to be slidable along the fitting direction of the two terminal housings 5 and 7, and a slide means 92 which makes the second fitting detection terminal 91 slide in accordance with the rotation of the cam 9a and electrically connects the first fitting detection terminal 90 to the second fitting detection terminal 91 when fitting the two terminal housings 5 and 7 and then rotating the cam 9a in the tightening direction.

In the present embodiment, the first fitting detection terminal 90 is provided on the first terminal housing 5 and the second fitting detection terminal 91 and the slide means 92 are provided on the second terminal housing 7.

As shown in FIG. 15, the first fitting detection terminal 90 is housed and held in the first fitting detection terminal case 93. The first fitting detection terminal case 93 is attached to the first fitting detection terminal case-attaching hole 10c of the first inner housing 10 and the first fitting detection terminal 90 is thereby fixed to the first terminal housing 5 via the first fitting detection terminal case 93 and the first inner housing 10.

The first fitting detection terminal 90 is composed of a crimping portion 90a for crimping and fixing a fitting detection cable 89, a terminal area 90b formed in a substantially square cylinder shape into which a tip portion of the second fitting detection terminal 91 is inserted, and a connecting portion 90c for connecting the crimping portion 90a to the terminal area 90b. A plate spring is provided inside the terminal area 90b. This plate spring presses the tip portion of the second fitting detection terminal 91 against the inner wall of the terminal area 90b to retain a contact point. Guide holes 93a for each guiding the tip portion of the second fitting detection terminal 91 into the terminal area 90b are formed at the front end portion of the first fitting detection terminal case 93. Edges at the rim of the guide hole 93a are chamfered to facilitate insertion of the second fitting detection terminal 91.

Two first fitting detection terminals 90 are aligned and held in the first fitting detection terminal case 93 although the illustration is omitted, and the fitting detection cables 89 extending from a non-illustrated fitting detection device are respectively connected to the both first fitting detection terminals 90.

The second fitting detection terminal 91 is housed and held in the second fitting detection terminal case 94. The second fitting detection terminal case 94 is formed in a cylindrical shape which opens on the front side in a sliding direction (on the front side in the fitting direction). The second fitting detection terminal 91 is formed in a substantially U-shape and is fixed inside the second fitting detection terminal case 94 so that the tip portions thereof face the opening. Edges at the tip portions of the second fitting detection terminal 91 are chamfered to facilitate insertion into the terminal area 90b of the first fitting detection terminal 90.

The slide means 92 has a case-side protrusion 94a provided on the second fitting detection terminal case 94 and a slide ring 95 rotating integrally with the cam 9a.

The slide ring 95 has a ring portion 95a rotating integrally with the cam 9a and a ring-side protrusion 96 coming in contact with the case-side protrusion 94a to slide the second fitting detection terminal case 94 when the ring portion 95a is rotated.

The ring portion 95a is formed in a disc shape and has a through-hole 95b formed at the middle portion to let the elastic member 15 pass through. In addition, an engaging wall 95c is formed on the ring portion 95a at a circumferential portion so as to protrude upward (toward the cam 9a) from the rim of the ring portion 95a. It is configured that the engaging wall 95c is engaged with the cut-out portion 9g of the cam 9a so that the cam 9a rotates integrally with the ring portion 95a.

The ring-side protrusion 96 is formed so as to protrude downward from the lower surface (opposite to the cam 9a) of the ring portion 95a. In the present embodiment, the ring-side protrusion 96 is composed of two protrusions, a front protrusion 96a formed along a circumferential direction of the ring portion 95a and a rear protrusion 96b.

The front protrusion 96a has an arc portion 97a formed in an arc shape along a circumferential direction of the ring portion 95a as viewed from the lower side and a protruding portion 97b protruding radially outward of the ring portion 95a at an end portion of the arc portion 97a opposite to the rear protrusion 96b. The arc portion 97a and the protruding portion 97b have rounded sidewalls. The rear protrusion 96b is formed in a column shape.

The case-side protrusion 94a is provided so as to protrude laterally (toward the slide ring 95) from the outer peripheral surface of the second fitting detection terminal case 94. In the present embodiment, a case-side auxiliary protrusion 94b is formed on the second fitting detection terminal case 94 on the front side in the sliding direction (on the front side in the fitting direction) with respect to the case-side protrusion 94a so as to protrude laterally from the outer peripheral surface of the second fitting detection terminal case 94.

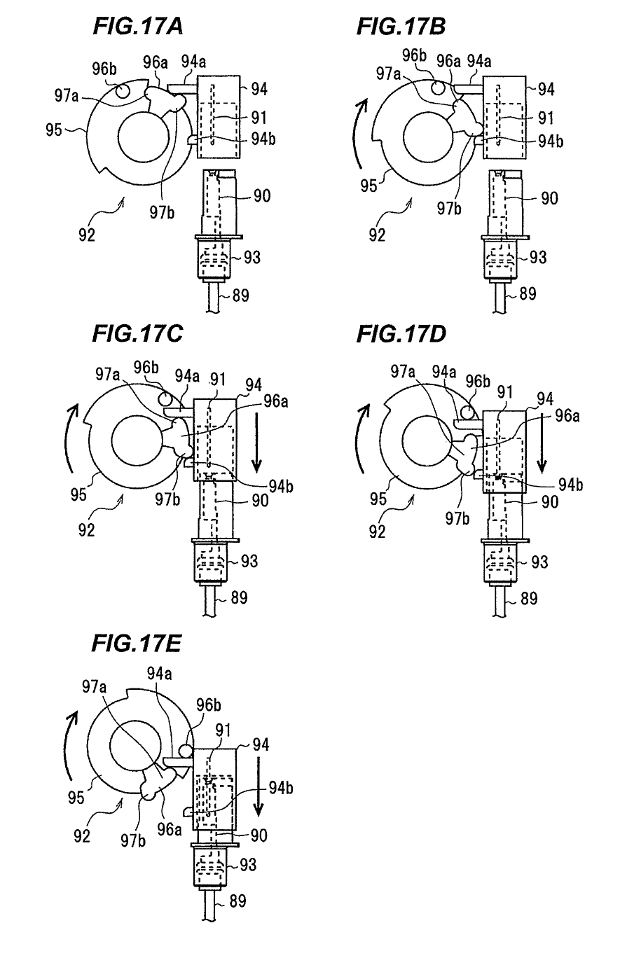

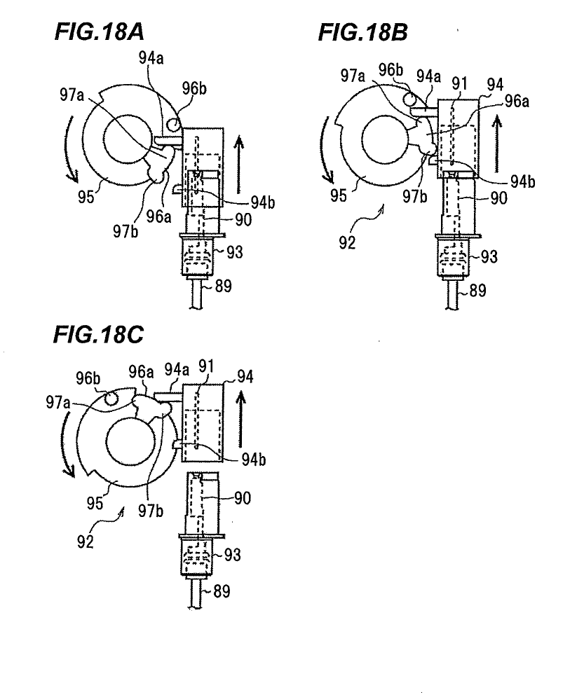

The operation of the fitting detection mechanism will be described below in reference to FIGS. 17A to 18C. Note that, FIGS. 17A to 18C show a positional relation between the first fitting detection terminal case 93, the second fitting detection terminal case 94 and the slide ring 95 as viewed from the lower side of FIG. 1.

At the release position where the cam 9a rotated in the direction opposite to the tightening direction is located, the case-side protrusion 94a is pressed backward in the sliding direction (upward in FIG. 17A) by the protruding portion 97b of the front protrusion 96a as shown in FIG. 17A and the second fitting detection terminal case 94 is restricted from moving forward in the sliding direction (downward in FIG. 17A).

By rotating the cam 9a in the tightening direction from this state, the slide ring 95 is rotated and the protruding portion 97b of the front protrusion 96a comes into contact with the case-side auxiliary protrusion 94b, as shown in FIG. 17B. The second fitting detection terminal case 94 is not pushed forward in the sliding direction until the front protrusion 96a comes into contact with the case-side auxiliary protrusion 94b, while the bolt 9b is pressed down in accordance with the rotation of the cam 9a and a pressing force is applied to each contact point via the elastic member 15.

By further rotating the cam 9a in the tightening direction, the protruding portion 97b of the front protrusion 96a butts against the case-side auxiliary protrusion 94b as shown in FIG. 17C and the second fitting detection terminal case 94 slides forward in the sliding direction (toward the first fitting detection terminal 90) in accordance with the rotation of the slide ring 95.

By further rotating the cam 9a in the tightening direction, the protruding portion 97b of the front protrusion 96a is disengaged from the case-side auxiliary protrusion 94b and the rear protrusion 96b comes into contact with the case-side protrusion 94a, as shown in FIG. 17D. In order to facilitate the disengagement of the front protrusion 96a at this time, an edge of the top end portion of the case-side auxiliary protrusion 94b on the rear side in the sliding direction (opposite to the first fitting detection terminal 90) is rounded.

By further rotating the cam 9a in the tightening direction, the rear protrusion 96b butts against the case-side protrusion 94a as shown in FIG. 17E and the second fitting detection terminal case 94 slides forward in the sliding direction (toward the first fitting detection terminal 90) in accordance with the rotation of the slide ring 95.

As a result, the front end portion of the first fitting detection terminal case 93 is pushed into the second fitting detection terminal case 94 and the tip portion of the second fitting detection terminal 91 into the terminal area 90b of the first fitting detection terminal 90, and the first fitting detection terminal 90 is thereby electrically connected to the second fitting detection terminal 91.

In the present embodiment, both tip portions of the U-shaped second fitting detection terminal 91 are respectively pushed into the terminal areas 90b of the two first fitting detection terminals 90 housed in the first fitting detection terminal case 93 and the two first fitting detection terminals 90 are electrically connected to each other via the second fitting detection terminal 91. As a result, a loop circuit is formed from a fitting detection device to another fitting detection device via the fitting detection cable 89, the first fitting detection terminal 90, the second fitting detection terminal 91, another first fitting detection terminal 90 and another fitting detection cable 89. The fitting detection device is configured that, e.g., voltage is applied to end portions of the both fitting detection cables 89 extending from the fitting detection devices and whether the two terminal housings 5 and 7 are fitted or not is determined based on whether or not a current flowing through the loop circuit is not less than a preset threshold.

At the tightened position where the cam 9a rotated in the tightening direction is located, the case-side protrusion 94a is sandwiched between the front protrusion 96a and the rear protrusion 96b as shown in FIG. 17E and the second fitting detection terminal case 94 is restricted from moving in the sliding direction.

As such, in the present embodiment, the slide means 92 is configured to electrically connect the first fitting detection terminal 90 to the second fitting detection terminal 91 after a pressing force is applied to each contact point when fitting the two terminal housings 5 and 7 and then rotating the cam 9a in the tightening direction. Thus, it is possible to configure such that an electric current can flow through each contact point only after properly applying a pressing force to each contact point and it is thus possible to improve safety.

Note that, it is only necessary to provide the rear protrusion 96b and the case-side protrusion 94a at the very least from the viewpoint of sliding the second fitting detection terminal case 94 toward the first fitting detection terminal 90 but, in this case, it is not possible to sufficiently provide a moving distance of the second fitting detection terminal case 94 in the sliding direction unless the size of the slide ring 95 is increased. Due to the configuration of the present embodiment in which the front protrusion 96a butts against the case-side auxiliary protrusion 94b to slide the second fitting detection terminal case 94 toward the first fitting detection terminal 90 and the rear protrusion 96b subsequently butts against the case-side protrusion 94a to slide the second fitting detection terminal case 94 toward the first fitting detection terminal 90, it is possible to sufficiently provide the moving distance of the second fitting detection terminal case 94 in the sliding direction even when the slide ring 95 is small and this allows the size of the entire connector 1 to be reduced.

When the cam 9a is rotated from the tightened position in the direction opposite to the tightening direction, the arc portion 97a of the front protrusion 96a comes into contact with the case-side protrusion 94a, as shown in FIG. 18A. When the cam 9a is further rotated, the arc portion 97a of the front protrusion 96a butts against the case-side protrusion 94a and the second fitting detection terminal case 94 slides in a direction opposite to the first fitting detection terminal 90 in accordance with the rotation of the slide ring 95, as shown in FIG. 18B. In the state shown in FIG. 18B, the first fitting detection terminal 90 and the second fitting detection terminal 91 are electrically disconnected but the pressing force is still applied to each contact point since the cam 9a does not reach the release position.

When the cam 9a is further rotated in the direction opposite to the tightening direction, the arc portion 97a of the front protrusion 96a is disengaged from the case-side protrusion 94a and the protruding portion 97b of the front protrusion 96a comes into contact with the case-side protrusion 94a as shown in FIG. 18C and, at the release position, the second fitting detection terminal case 94 is restricted from moving forward in the sliding direction. Note that, in order to facilitate the disengagement of the front protrusion 96a, an edge of the top end portion of the case-side protrusion 94a on the front side in the sliding direction (on the first fitting detection terminal 90 side) is rounded.

As such, in the present embodiment, the slide means 92 is configured to electrically disconnect the first fitting detection terminal 90 from the second fitting detection terminal 91 and subsequently to release each contact point from the pressing force when the cam 9a is rotated from the tightened position in the direction opposite to the tightening direction. As a result, it is possible to release each contact point from the pressing force after securely interrupting an electric current flowing through each contact point and then to allow the two terminal housings 5 and 7 to be detached, which further improves safety.

Effects of the Present Embodiment

The effects of the present embodiment will be described.

The connector 1 in the present embodiment is provided with the connecting member 9 for collectively fixing and electrically connecting the plural first connecting terminals 4a to 4c and the plural second connecting terminals 6a to 6c at each contact point by rotating the cam 9a in the tightening direction and thereby pressing each contact point, the first fitting detection terminal 90 provided on one of the first terminal housing 5 and the second terminal housing 7, the second fitting detection terminal 91 provided on the other of the first terminal housing 5 and the second terminal housing 7 so as to be slidable along the fitting direction of the two terminal housings 5 and 7, and the slide means 92 which makes the second fitting detection terminal 91 slide in accordance with the rotation of the cam 9a and electrically connects the first fitting detection terminal 90 to the second fitting detection terminal 91 when fitting the two terminal housings 5 and 7 and then rotating the cam 9a in the tightening direction.

Such a configuration allows a single operation of rotating the cam 9a to apply a pressing force to each contact point as well as to electrically connect the first fitting detection terminal 90 to the second fitting detection terminal 91 and it is thus possible to significantly improve workability of connection work to connect the two connector portions 2 and 3.

In addition, in the connector 1, the both fitting detection terminals 90 and 91 are electrically connected in the state that each contact point is fixed. Therefore, unlike the conventional art, there is no possibility of spark generation due to detachment of two terminal housings while the both fitting detection terminals 90 and 91 are electrically connected to each other and it is thus possible to improve safety during the connection work.

In other words, it is possible to realize the laminated-type connector 1 which allows the fitting of the terminal housings 5 and 7 to be detected without impairing workability and safety of the connection work.

In addition, the connector 1 is provided with the insulating member assembly 100 formed by connecting the plural insulating members 8a to 8d to each other and having the insulating member restricting means 101 for restricting movement of the insulating members 8a to 8d in a direction perpendicular to a lamination direction of the laminated structure. Therefore, it is possible to reduce positional misalignment of the insulating members 8a to 8d even when a force (e.g., a force to pull the cables 61a to 61c or a force to push the cables 61a to 61c into the first connector portion 2) is applied to the cables 61a to 61c, and as a result, it is possible to prevent the second connecting terminals 6a to 6c from butting against the insulating members 8a to 8d at the time of connecting the two connector portions 2 and 3 and a fitting operation can be smoothly carried out. In addition, the connector 1 does not use a retaining jig unlike conventional connectors and is thus small.

Furthermore, in the connector 1, the first terminal insertion holes 102 and the second terminal insertion holes 103 are formed on the insulating member assembly 100 in order to fit the two terminal housings 5 and 7 such that a length direction of the first connecting terminals 4a to 4c crosses that of the second connecting terminals 6a to 6c. Therefore, although the connector 1 has a laminated structure, it is possible to reduce a protruding length from the device when directly connected to the device and it is thus possible to effectively use a wiring space.

It should be noted that the present invention is not intended to be limited to the embodiment, and the various changes can be made without departing from the gist of the present invention.

For example, the case where the first fitting detection terminal 90 is a female terminal and the second fitting detection terminal 91 is a male terminal has been explained in the embodiment, male and female may be reversed.

In addition, the arc portion 97a and the protruding portion 97b are integrated to form the front protrusion 96a in the embodiment but may be separated such that the front protrusion 96a is composed of two protrusions. Likewise, the shapes of the rear protrusion 96b, the case-side protrusion 94a and the case-side auxiliary protrusion 94b, etc., can be appropriately changed.

The embodiment assumes the use of a three-phase AC power line, however, according to the technical idea of the invention, it may be, e.g., a connector for a vehicle which is configured to collectively connect lines used for different purposes such as a three-phase AC power line between a motor and an inverter and a two-phase DC power line for air conditioner. Since the configuration described above allows one connector to collectively connect power lines used for different purposes, it is not necessary to prepare different connectors for each intended purpose and it is thus possible to contribute to space saving and cost reduction.

In addition, surfaces of the first connecting terminals 4a to 4c and of the second connecting terminals 6a to 6c may be each roughened by a knurling process to increase frictional force so as to make the terminals difficult to move, thereby strengthening the fixation at each contact point.

In addition, although the case where the first connector portion 2 is attached to the device has been described in the embodiment, it is possible to configure such that the first connecting terminals 4a to 4c are provided at end portions of cables to connect the cables to each other.

Furthermore, although the first connecting terminals 4a to 4c are inserted through the through-holes 10a of the first inner housing 10 and are fixed to the first inner housing 10 in the embodiment, the first inner housing 10 may be integrally formed with the first connecting terminals 4a to 4c by insert molding.

In addition, although the case where the first insulating members 8b to 8d are attached to the second connecting terminals 6a to 6c by fitting the second connecting terminals 6a to 6c to the fitting grooves 83 has been described in the embodiment, the first insulating members 8b to 8d may be fixed to the second connecting terminals 6a to 6c by insert molding or by press-fitting the second connecting terminals 6a to 6c into the first insulating members 8b to 8d.

In addition, although a cable excellent in flexibility is used as the cables 61a to 61c in the embodiment, a rigid cable may be used.

In addition, in the embodiment, a direction of the connecting member 9 may be either substantially horizontal or substantially vertical when the connector is in use. In other words, a direction in a usage state is not a requirement in the use conditions of the connector of the present embodiment.

In addition, although the bolt 9b of the connecting member 9 presses the second insulating member 8a adjacent thereto via the elastic member 15 which is a portion of the connecting member 9 in the embodiment, the adjacent second insulating member 8a may be pressed directly by the bolt 9b, not via the elastic member 15.

In addition, although the case of providing the connecting member 9 on only one side of the first terminal housing 5 has been described in the embodiment, the connecting member 9 may be provided on both sides of the first terminal housing 5 so that a pressing force is applied to each contact point by the two connecting members 9 provided on the both sides.

In addition, the first terminal housing 5 may be a part of a housing of a device such as inverter. In other words, the connector 1 may be configured not to include the first connector portion 2. In this case, the wire harness of the invention is the cables 61a to 61c with the second connector portion 3 provided at an end portion thereof.

Although a packing is provided on the first terminal housing 5 (in the groove 22 of the cylindrical body 20) in the embodiment, the packing may be provided on the second terminal housing 7. In this case, it is preferable that a groove for placing the packing be formed on an inner periphery of the second terminal housing 7.

What is claimed is:

1. A connector, comprising:
a first terminal housing for housing a plurality of first connecting terminals aligned;
a second terminal housing for housing a plurality of second connecting terminals aligned;
a plurality of insulating members aligned and housed in the second terminal housing;
a laminated structure that the plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the first terminal housing is fitted to the second terminal housing;
a connecting member for collectively fixing and electrically connecting the plurality of first connecting terminals and the plurality of second connecting terminals at each contact point by rotating a cam in a tightening direction and thereby pressing each contact point;
a first fitting detection terminal provided on one of the first and second terminal housings;
a second fitting detection terminal provided on the other of the first and second terminal housings so as to be slidable along a fitting direction of the two terminal housings; and
a slide means that makes the second fitting detection terminal slide in accordance with the rotation of the cam and electrically connects the first fitting detection terminal to the second fitting detection terminal when fitting the two terminals housings and then rotating the cam in the tightening direction.

2. The connector according to claim 1, wherein the slide means is configured to electrically connect the first fitting detection terminal to the second fitting detection terminal after a pressing force is applied to each contact point when fitting the two terminals housings and then rotating the cam in the tightening direction.

3. The connector according to claim 1, wherein the slide means is configured to electrically disconnect the first fitting detection terminal from the second fitting detection terminal when the cam is rotated from a tightened position in a direction opposite to the tightening direction.

4. The connector according to claim 3, wherein the slide means is configured to electrically disconnect the first fitting detection terminal from the second fitting detection terminal and subsequently to release each contact point from the pressing force when the cam is rotated from the tightened position in the direction opposite to the tightening direction.

5. The connector according to claim 1, further comprising a second fitting detection terminal case for holding the second fitting detection terminal,
wherein the slide means comprises a case-side protrusion provided on the second fitting detection terminal case and a slide ring comprising a ring portion rotating integrally with the cam and a ring-side protrusion coming in contact with the case-side protrusion to slide the second fitting detection terminal case when the ring portion is rotated.

6. The connector according to claim 5, wherein the ring-side protrusion comprises two protrusions, a front protrusion formed along a circumferential direction of the ring portion and a rear protrusion,
wherein the rear protrusion butts against the case-side protrusion to slide the second fitting detection terminal case when fitting the two terminals housings and then rotating the cam in the tightening direction, and
wherein the front protrusion butts against the case-side protrusion to slide the second fitting detection terminal case in a direction opposite to the first fitting detection terminal when the cam is rotated from a tightened position in a direction opposite to the tightening direction.

7. The connector according to claim 6, further comprising a case-side auxiliary protrusion formed on the second fitting detection terminal case on a front side in a sliding direction with respect to the case-side protrusion,
wherein, when fitting the two terminals housings and then rotating the cam in the tightening direction, the front protrusion butts against the case-side auxiliary protrusion to slide the second fitting detection terminal case toward the first fitting detection terminal and subsequently the rear protrusion butts against the case-side protrusion to slide the second fitting detection terminal case toward the first fitting detection terminal.

8. A connector, comprising:
a second terminal housing for housing a plurality of second connecting terminals aligned;
a plurality of insulating members aligned and housed in the second terminal housing;
a laminated structure that a plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the second terminal housing is fitted to a first terminal housing that is a housing to be fitted to the second terminal housing and houses the plurality of first connecting terminals aligned;
a connecting member for collectively fixing and electrically connecting the plurality of first connecting terminals and the plurality of second connecting terminals at each contact point by rotating a cam in a tightening direction and thereby pressing each contact point;
a second fitting detection terminal provided on the second terminal housing so as to be slidable along a fitting direction of the two terminal housings; and
a slide means that makes the second fitting detection terminal slide in accordance with the rotation of the cam and electrically connects the first fitting detection terminal provided on the first terminal housing to the second fitting detection terminal when fitting the two terminals housings and then rotating the cam in the tightening direction.

9. A wire harness, comprising:
a plurality of cables;
a plurality of second connecting terminals to be connected to the plurality of cables;
a second terminal housing for housing the plurality of second connecting terminals aligned;
a plurality of insulating members aligned and housed in the second terminal housing;
a laminated structure that a plurality of first connecting terminals and the plurality of second connecting terminals are alternately arranged so that one surface of the plurality of first connecting terminals faces one surface of the plurality of second connecting terminals to form pairs and to form a plurality of contact points sandwiched between the plurality of insulating members when the second terminal housing is fitted to a first terminal housing that is a housing to be fitted to the second terminal housing and houses the plurality of first connecting terminals aligned;
a connecting member for collectively fixing and electrically connecting the plurality of first connecting terminals and the plurality of second connecting terminals at each contact point by rotating a cam in a tightening direction and thereby pressing each contact point;
a second fitting detection terminal provided on the second terminal housing so as to be slidable along a fitting direction of the two terminal housings; and
a slide means that makes the second fitting detection terminal slide in accordance with the rotation of the cam and electrically connects the first fitting detection terminal provided on the first terminal housing to the second fitting detection terminal when fitting the two terminals housings and then rotating the cam in the tightening direction.
